(19) United States
(12) Patent Application Publication
(10) Pub. No.: US 2026/0051778 A1
(43) Pub. Date: Feb. 19, 2026

(54) MOTOR STATOR STRUCTURE

(71) Applicant: ASIA VITAL COMPONENTS (CHINA) CO., LTD., Shenzhen (CN)

(72) Inventors: Shunjie Du, Shenzhen (CN); Chih-Cheng Lai, Shenzhen (CN)

(21) Appl. No.: 18/814,859

(22) Filed: Aug. 26, 2024

(30) Foreign Application Priority Data
Aug. 16, 2024 (TW) 113130948

(51) Int. Cl. H02K 3/28; H02K 1/16

(52) U.S. Cl. CPC H02K 3/28; H02K 1/16

(57) ABSTRACT

A motor stator structure includes a plurality of windings sequentially wound clockwise and counterclockwise alternately around a clockwise and a counterclockwise winding tooth section of six sets of tooth sections spaced along an iron core. A stator slot is defined between any two adjacent clockwise and counterclockwise winding tooth sections. Each of the windings has a first and a second wire head and a winding wire section connected to between the first and the second wire head. The winding wire section is wound clockwise around the clockwise winding tooth section of one set of tooth sections and then extended across to wind counterclockwise around the counterclockwise winding tooth section of the same set of tooth sections, such that the first and the second wire head are separately exposed from each stator slot and can be easily recognized when being welded to a circuit board to enable efficient motor production.

This application claims the priority benefit of Taiwan patent application number 113130948 filed on Aug. 16, 2024, the disclosure of which is hereby incorporated by reference in its entirety.

### FIELD OF THE INVENTION

The present invention relates to a motor stator structure, and more particularly, to a motor stator structure that has wire heads exposed from the windings thereof to be evenly distributed along a stator iron core, so that the wire heads are easily recognizable to enable upgraded motor assembling efficiency.

### BACKGROUND OF THE INVENTION

Most of the three-phase motors for fans use a stator with 12 slots and 10 poles or with 12 slots and 14 poles. A conventional stator 1 as shown in FIGS. 1A and 1B includes twelve tooth sections having six windings wound therearound; these six windings are wound in accordance with a three-phase concentrated winding with two parallel circuit branches. Generally, the windings on the twelve tooth sections (see numerals 1˜12 in FIG. 1B indicate the sequence of the tooth sections) of the stator 1 in FIGS. 1A and 1B are wound in the following sequence, i.e. a first winding 101 is wound clockwise around the first tooth section 111 (see FIG. 1B, “clockwise” indicates the winding is wound clockwise); and then the first winding is extended across to continuously wind counterclockwise around the second tooth section 112 (see FIG. 1B, “counterclockwise” indicates the winding is wound counterclockwise). A second winding 102 is wound counterclockwise around the third tooth section 113 and then extended across to wind clockwise around the fourth tooth section 114. A third winding 103 is wound clockwise around the fifth tooth section 115 and then extended across to continuously wind counterclockwise around the sixth tooth section 116. A fourth winding 104 is wound counterclockwise around the seventh tooth section 117 and then extended across to continuously wind clockwise around the eighth tooth section 118. A fifth winding 105 is wound clockwise around the ninth tooth section 119 and then extended across to wind counterclockwise around the tenth tooth section 120. A sixth winding 106 is wound counterclockwise around the eleventh tooth section 121 and then extended across to wind clockwise around the twelfth tooth section 122. Each winding has two exposed wire heads 1081, 1082, and the six windings have total twelve exposed wire heads.

The above-described conventional stator winding manner has some disadvantages, i.e. a part of the two adjacent tooth sections on the stator (including the second and third tooth sections 112, 113; the sixth and seventh tooth sections 116 117; and the tenth and eleventh tooth sections 120, 121) respectively define a stator slot 14 between them and there will be two wire heads 1081, 1082 located in each of these stator slots, as shown in FIG. 1A, while the stator slots 14 respectively defined between some other adjacent tooth sections only have one wire head 1081 or 1082 exposed therefrom. Further, there are also other adjacent tooth sections (such as the fourth and fifth tooth sections 114, 115; the eighth and ninth tooth sections 118, 119; and the first and twelfth tooth sections 111, 122) have not wire head 14 exposed from the stator slots 14 defined between them. Therefore, the wire heads are not evenly distributed on the stator 1. Under this situation, the wire heads 1081, 1082 of wrong windings tend to be welded to the printed circuit board (PCB) when assembling and wiring the stator 1 to result in inferior product quality. Further, in the case there are two wire heads 1081, 1082 exposed from the same one stator slot 14, it is necessary to find a way at the stage of planning and designing the circuit board as how to handle two pads at the same position on the printed circuit board. This would inevitably cause difficulty in circuit board design and increase the complication of wiring on the circuit board to result in lowered efficiency in overall motor assembling and production.

In addition, since the adjacent windings are wound in two opposite directions, for example, the first winding 101 and the second winding 102; the third winding 103 and the fourth winding 104; and the fifth and the sixth winding 105, 106 all are wound in opposite directions. Under this condition, when the winding of the stator 1 is formed on a winding machine, it is necessary to make some particular adjustments, for example, the winding program must be modified and could not be duplicated. This would cause increased uncontrollable factors in the manufacturing process and would lead to the quality problem, particularly the stator having higher slot fill factor.

### SUMMARY OF THE INVENTION

A primary object of the present invention is to overcome the above problems by providing a motor stator structure that has evenly distributed and easily recognizable winding wire heads to facilitate upgraded production efficiency.

Another object of the present invention is to provide the above motor stator structure that has only one wire head exposed from each stator slot, so that the circuit board can be designed to have pads evenly distributed thereon.

To achieve the above and other objects, the motor stator structure of the present invention includes a stator iron core and a plurality of windings. The stator iron core includes a ring section and six sets of tooth sections respectively having a clockwise and a counterclockwise winding tooth section. The clockwise and the counterclockwise winding tooth sections are alternately spaced on an inner circumferential surface of the ring section, such that a stator slot is defined between any two adjacent clockwise and counterclockwise winding tooth sections on each and any two adjacent sets of tooth sections. The windings are sequentially wound clockwise and counterclockwise alternately around the clockwise and counterclockwise winding tooth sections, respectively, of the six sets of tooth sections. Each of the windings has a first and a second wire head and a winding wire section connected to between the first and the second wire head. The winding wire section is wound clockwise around the clockwise winding tooth section of one set of tooth sections and then extended across to wind counterclockwise around the counterclockwise winding tooth section of the same set of tooth sections, such that the first and the second wire head are separately exposed from each stator slot.

In the present invention, the windings are sequentially wound clockwise and counterclockwise around the six sets of tooth sections, so that the wires of the windings on the six sets of tooth sections are wound in consistent directions and the wire heads of each winding are respectively exposed from one stator slot. Therefore, the wire heads are evenly distributed on the stator iron core and easily recognizable for welding to the circuit board without making any mistake, enabling the motor to be efficiently assembled and have upgraded quality.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1A is a perspective view of a conventional motor stator;

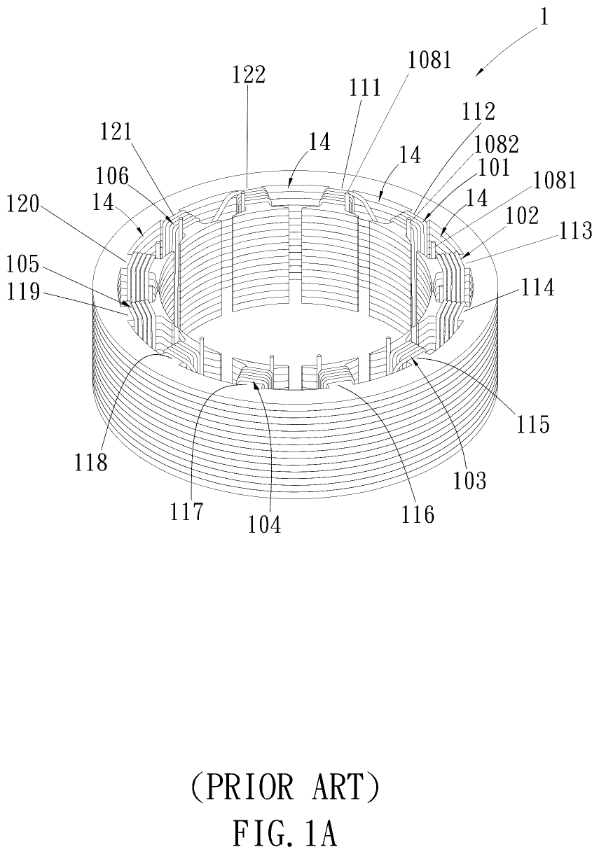

FIG. 1B is a net of conventional three-phase windings with 12 slots and 10 poles;

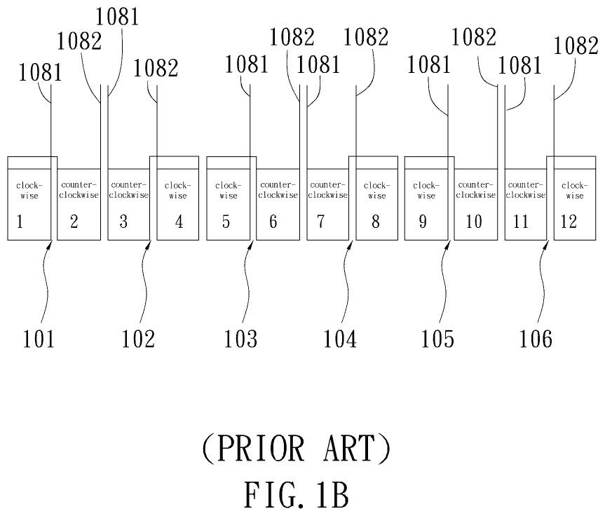

FIG. 2 is a perspective view showing an inner rotor type motor stator structure according to the present invention;

FIG. 3 is a net of three-phase windings with 12 slots and 10 poles for the motor stator structure according to the present invention; and

FIG. 4 shows a delta connection of the three-phase windings with 12 slots and 10 poles for the motor stator structure according to the present invention.

### DETAILED DESCRIPTION OF THE PREFERRED EMBODIMENTS

The present invention will now be described with a preferred embodiment thereof by referring to the accompanying drawings.

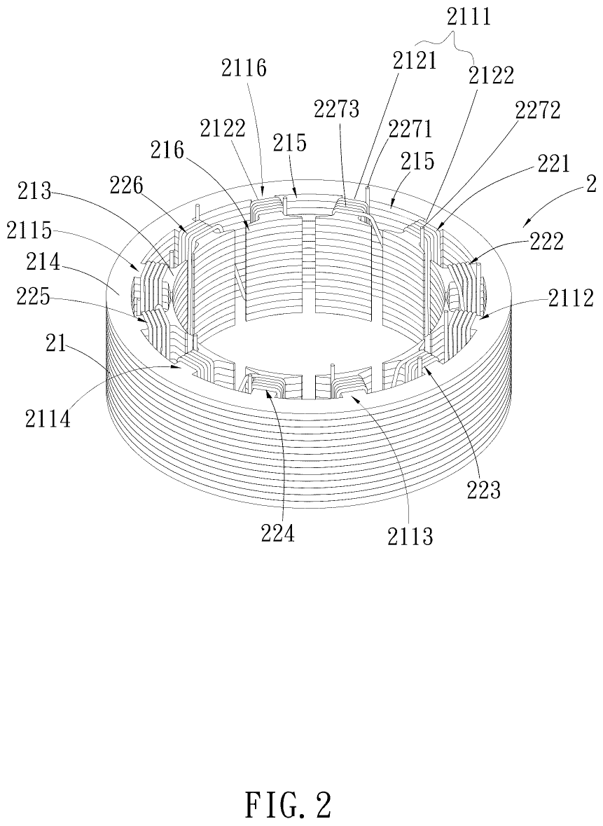

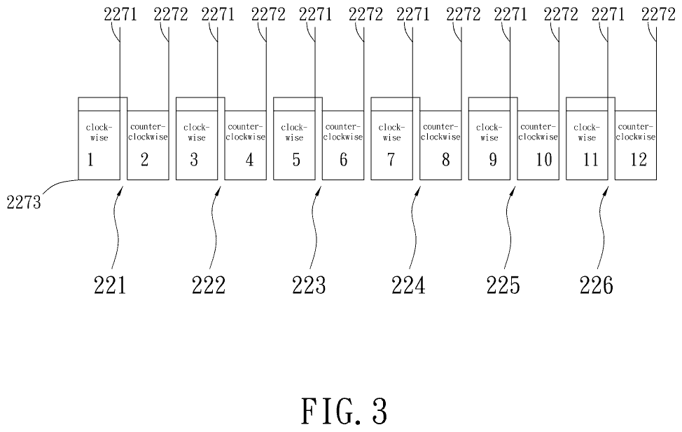

The present invention provides a motor stator structure 2. Please refer to FIGS. 2 and 3. The motor stator structure 2 is applicable to an outer rotor type motor or an inner rotor type motor, such as a fan motor or a pump motor. In the illustrated preferred embodiment, the motor stator structure 2 is applied to a three-phase inner rotor type fan motor with 12 slots and 10 poles. The fan motor includes a stator (i.e. the motor stator structure) 2 and a rotor located at a radially inner side of the stator and being provided with a plurality of magnetic elements. However, it is understood the present invention is not intended to be limited to the preferred embodiment in any way.

The motor stator structure 2 includes a stator iron core 21 and a plurality of windings. The stator iron core 21 includes six sets of tooth sections 2111, 2112, 2113, 2114, 2115, 2116, and a ring section 214. All the sets of tooth sections 2111˜2116 include a clockwise winding tooth section 2121 and a counterclockwise winding tooth section 2122, which are arranged alternately along a radially inner surface of the ring section 214. In the illustrated preferred embodiment, the six clockwise winding tooth sections 2121 and the six counterclockwise winding tooth sections 2122 are equally spaced while being alternately arranged along the radially inner surface of the ring section 214 to extend radially inward. All the clockwise winding tooth sections 2121 and counterclockwise winding tooth sections 2122 respectively have a pole piece 213 located at a free end thereof. The free end of each of the tooth sections 2121, 2122 are laterally extended to form the pole piece 213.

A stator slot 215 is defined between any two adjacent clockwise and counterclockwise winding tooth sections 2121, 2122 on the same set of tooth sections and on any two adjacent sets of tooth sections. In the illustrated preferred embodiment, total twelve stator slots 215 are defined by the six sets of tooth sections 2111˜2116. For example, the first stator slot 215 is formed between the clockwise winding tooth section 2121 and the counterclockwise winding tooth section 2122 of the first set of tooth sections 2111, and the second stator slot 215 is formed between the counterclockwise winding tooth section 2122 of the first set of tooth sections 2111 and the clockwise winding tooth section 2121 of the second set of tooth sections 2112 located adjacent to the first set of tooth sections 2111. Similarly, the remaining stator slots 215 from the third stator slot 215 to the twelfth stator slot 215 are sequentially formed in the same manner as described above.

The stator iron core 21 is an inner rotor type stator iron core 21, which defines a central hollow receiving space 216. The central hollow receiving space 216 is communicable with the stator slots 215 defined on the six sets of tooth sections 2111˜2116 for receiving the rotor therein. The magnetic elements are provided on a radial outer side of the rotor and respectively have two magnetic poles (a north pole N and a south pole S). The magnetic poles of the magnetic elements and the stator slots 215 of the stator iron core 21 together form a motor structure of 12 slots and 10 poles. However, the present invention is not necessarily limited to the illustrated preferred embodiment. In practical implementation of the present invention, the fan motor can be a 12-slot and 14-pole structure. That is, the stator slots 215 of the stator iron core 21 and the magnetic poles of the magnetic elements of the rotor together form a motor structure of 12 slots and 14 poles.

Please refer to FIGS. 2 and 3. The windings of the motor stator structure 2 are sequentially arranged along the arraying direction of the six sets of tooth sections 2111˜2116 on the ring section 214 to be wound clockwise and counterclockwise alternately around the clockwise winding tooth section 2121 and the counterclockwise winding tooth section 2122 of all the six sets of tooth sections 2111˜2116. In FIG. 3, “clockwise” indicates the winding is wound clockwise, and “counterclockwise” indicates the winding is wound counterclockwise; and numerals 1˜12 indicate the sequence in which the clockwise and counterclockwise winding tooth sections are arrayed on the ring section 214. In the illustrated preferred embodiment, there are total six windings 221, 222, 223, 224, 225, 226 sequentially corresponding to the six sets of tooth sections 2111˜2116. That is, the first winding 221 is wound on the first set of tooth sections 2111, the second winding 222 is wound on the second set of tooth section 2112, and so on. And, the windings are three-phase concentrated windings having two parallel circuit branches.

All the windings (i.e. the first to the sixth winding 221˜226) have a first wire head 2271, a second wire head 2272, and a winding wire section 2273 located between and connected to the first wire head 2271 and the second wire head 2272. The winding wire section 2273 of each winding is wound clockwise around the clockwise winding tooth section 2121 of each set of tooth sections and is then uninterruptedly extended to the counterclockwise winding tooth section 2122 of the same set of tooth sections to be wound counterclockwise, and the first wire head 2271 and the second wire head 2272 are separately guided from an inner side to an outer side of each stator slot 215 to expose therefrom. For example, as shown in FIG. 3, the first wire head 2271 of the first winding 221 is exposed from and located above the first stator slot between the clockwise winding tooth section 2121 and the counterclockwise winding tooth section 2122 of the first set of tooth sections 2111. Then, the winding wire section 2273 of the first winding 221 is clockwise wound sequentially from the right side, the bottom side, the left side to the top side of the clockwise winding tooth section 2121. Thereafter, the winding wire section 2273 of the first winding 221 is extended across from the top side of the clockwise winding tooth section 2121 to the left side of the adjacent counterclockwise winding tooth section 2122 and then counterclockwise wound sequentially from the left side, the bottom side, the right side and the top side of the counterclockwise winding tooth section 2122 of the first set of tooth sections 2111. Lastly, the second wire head 2272 of the first winding 221 is guided from an inner side to an outer side to project from the second stator slot 215 located between the counterclockwise winding tooth section 2122 of the first set of tooth sections 2111 and the clockwise winding tooth section 2121 of the adjacent second set of tooth sections 2112, such that the first wire head 2271 and the second wire head 2272 of the first winding 221 are exposed from the first and the second stator slot 215, respectively.

The second to the sixth winding 222˜226 are sequentially wound around the clockwise winding tooth section 2121 and the counterclockwise winding tooth sections 2122 of the second to the sixth set of tooth section 2112˜2116 correspondingly in the same winding manner and winding direction as that described above for the first winding 221. With the above arrangements, the wire heads of each winding are exposed from two adjacent stator slots 215. Therefore, each of the stator slots 215 has only one wire head exposed therefrom, and there are total twelve wire heads. In this way, the wire heads guided out of the windings can be effectively and evenly distributed while being easily recognizable to avoid making mistakes when welding the wire heads to a circuit board and accordingly, to enable effectively enhanced motor assembling efficiency and productivity. Further, since only one wire head is properly guided out of every stator slot 215, it enables evenly distributed pads and accordingly, facilitates convenient circuit board planning and designing. Further, all the windings are wound in consistent directions, so that the winding program for forming the windings on a winding machine is simple and duplicable to effectively reduce uncontrollable factors and in turn effectively upgrade the quality of products.

For the purpose of showing clearly the windings wounded around the clockwise winding tooth section 2121 and the counterclockwise winding tooth section 2122 of the six sets of tooth sections 2111˜2116 according to the preferred embodiment, an upper and a lower insulation support connected to a top side and a bottom side of each set of tooth sections are omitted from FIG. 2. In practical implementation of the present invention, each winding may be wound around the upper and the lower insulation support of every set of tooth sections with or without a slot insulation paper provided therewith. Alternatively, the upper and the lower insulation supports can be omitted from all the sets of tooth sections. In the latter case, an insulation material is injection molded to directly wrap around the whole outer surface of the stator iron core 21, so that the windings are directly wound around the sets of tooth sections being wrapped by the insulation layer. In this manner, it is able to effectively achieve the effect of reduced stator thickness and increased turns of windings.

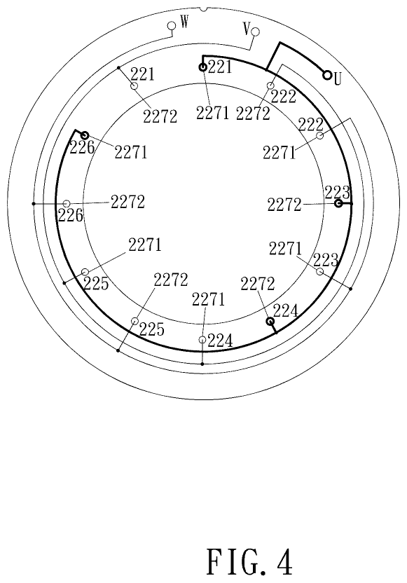

The first and the second wire heads 2271, 2272 of the windings 221˜226 wound around the six sets of tooth sections 2111˜2116 on the stator iron core 21 may be connected in a star configuration or in a delta configuration, depending on the motor power and the required torque. Please refer to FIG. 4. The first wire head 2271 of the first winding 221, the second wire head 2272 of the third winding 223, the second wire head 2272 of the fourth winding 224, and the first wire head 2271 of the sixth winding 226 are connected to together form a U-phase terminal; the first wire head 2271 of the third winding 223 and the first wire head 2271 of the second winding 222 as well as the second wire head 2272 of the fifth and the sixth winding are connected to together form a W-phase terminal; and the second wire head 2272 of the first and the second winding 221, 222 as well as the first wire head 2271 of the fourth and the fifth winding 224, 225 are connected to together form a V-phase terminal to thereby form the winding connection in the delta configuration with the U-, V-, and W-phase terminals being the power source.

In the illustrated preferred embodiment, the motor stator structure 2 of the present invention is applied to an inner rotor type three-phase fan motor. However, it is understood the present invention is not necessarily restricted to the above application. In other alternative embodiment, the motor stator structure 2 may be applied to an outer rotor type three-phase fan motor. In this case, the stator iron core 21 is accordingly, an outer rotor type stator iron core 21 with the rotor disposed on a radially outer side of the motor stator structure 2.

In the present invention, since the windings 221˜226 are sequentially wound clockwise and counterclockwise alternately around the clockwise winding tooth section 2121 and the counterclockwise winding tooth section 2122 of all the six sets of tooth sections 2111˜2116, there is only one wire head guided out of each stator slot 215. Therefore, the windings 221˜226 and the wire heads 2271, 2272 are evenly distributed on the stator iron core 21 to facilitate easy recognition of the correct wire head without making mistakes during welding on the circuit board of the fan, and the assembling efficiency and the product quality can be upgraded.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A motor stator structure comprising:
a stator iron core including six sets of tooth sections and a ring section; every set of tooth sections including a clockwise winding tooth section and a counterclockwise winding tooth section, and the clockwise winding tooth sections and the counterclockwise winding tooth sections of the six sets of tooth sections being alternately arranged and spaced along an inner circumferential surface of the ring section, such that a stator slot is defined between any two adjacent clockwise and counterclockwise winding tooth sections on the same set of tooth sections and on any two adjacent sets of tooth sections; and
a plurality of windings being sequentially wound clockwise and counterclockwise alternately around the clockwise winding tooth section and the counterclockwise winding tooth section of all the six sets of tooth sections, and each winding having a first wire head, a second wire head, and a winding wire section located between and connected to the first and the second wire head; the winding wire section of each winding on one set of tooth sections being wound clockwise around the clockwise winding tooth section of the set of tooth sections and then extended uninterruptedly to wind counterclockwise around the counterclockwise winding tooth section of the same set of tooth sections; and the first and the second wire head being guided outward to expose from each stator slot, respectively.

2. The motor stator structure as claimed in claim 1, wherein the windings are connected in a delta configuration.

3. The motor stator structure as claimed in claim 1, wherein the stator iron core has a central hollow receiving space for receiving a rotor therein; the rotor having a plurality of magnetic elements provided thereon, and the stator slots formed on the stator iron core and the magnetic elements on the rotor together defining one of a 12-slot/10-pole motor structure and a 12-slot/14-pole motor structure.

4. The motor stator structure as claimed in claim 1, wherein the stator iron core is selected from the group consisting of an inner rotor type stator iron core and an outer rotor type stator iron core.
